(19) United States
(12) Patent Application Publication
(10) Pub. No.: US 2016/0259187 A1
(43) Pub. Date: Sep. 8, 2016

(54) OPTICAL MODULATION DEVICE AND DRIVING METHOD THEREOF

(71) Applicant: SAMSUNG DISPLAY CO., LTD., Yongin-si (KR)

(72) Inventors: Jong Suk Lee, Asan-si (KR); Yoon Kyung Park, Seoul (KR); Seung Jun Jeong, Hwaseong-si (KR)

(21) Appl. No.: 14/860,566

(22) Filed: Sep. 21, 2015

(30) Foreign Application Priority Data
Mar. 6, 2015 (KR) 10-2015-0031622

(51) Int. Cl. G02F 1/137

(52) U.S. Cl. CPC G02F 1/137; G02F 2001/133746

(57) ABSTRACT

An exemplary embodiment of the present invention provides a driving method of a liquid crystal lens panel, including a driving method of a liquid crystal lens panel that includes a first plate including a first region, a second region, and first electrodes at the first region and the second region; a second plate facing the first plate and including second electrodes that face the first electrodes; and a liquid crystal layer between the first plate and the second plate to include a plurality of liquid crystal molecules, including: forming a backward phase slope by applying a first driving signal to the first electrodes and the second electrodes which correspond to the first region; and forming a forward phase slope by applying a second driving signal that is different from the first driving signal to the first electrodes and the second electrodes which correspond to the second region.

### CROSS-REFERENCE TO RELATED APPLICATION

This application claims priority to and the benefit of Korean Patent Application No. 10-2015-0031622 filed in the Korean Intellectual Property Office on Mar. 6, 2015, the entire contents of which are incorporated herein by reference.

### BACKGROUND

1. Field

Embodiments of the present invention relate to a liquid crystal lens panel and a driving method thereof.

2. Description of the Related Art

Recently, optical display devices using an optical modulation device for modulating characteristics of light have been actively developed. For example, as optical display devices for displaying a 3D image draw attention, an optical modulation device is used to divide an image with different viewpoints to be transmitted so that a viewer can perceive the image as a stereoscopic image. A lens, a prism, and the like for altering a path of light to transmit the image of the display device to a desired viewpoint, are optical modulation devices that can be used in an autostereoscopic 3D image display device.

When polarized light passes through the optical modulation device such as a phase retarder, its polarization state is changed. For example, when circularly polarized light is incident on a half-wave plate, the circularly polarized light is emitted with its rotation direction inversely changed. For example, when right circularly polarized light passes through the half-wavelength plate, left circularly polarized light is emitted. For example, when left circularly polarized light passes through the half-wave plate, right circularly polarized light is emitted.

Liquid crystals may be used to easily adjust the optical axis of the optical modulation device such as the half-wave plate according to the position thereof. In the optical modulation device implemented as a phase retarder using the liquid crystals, long axes of liquid crystal molecules, which are arranged by applying an electric field to a liquid crystal layer, may be rotated to cause different phase modulations according to the position. The phase of the light emitted after passing through the optical modulation device may be determined by the directions of the longer axes of the aligned liquid crystal molecules, i.e., an azimuthal angle.

To implement lenses by performing continuous phase modulation by use of an optical modulation device including a liquid crystal, liquid crystal molecules are arranged such that their long axes are continuously changed.

The above information disclosed in this Background section is only to enhance the understanding of the background of the invention, and therefore it may contain information that does not form prior art.

### SUMMARY

Embodiments of the present invention include a liquid crystal lens panel capable of easily adjusting planar rotation angles of liquid crystal molecules to modulate light phases and controlling rotation directions of the liquid crystal molecules to make various light diffraction angles.

An exemplary embodiment of the present invention provides a driving method of a liquid crystal lens panel that includes a first plate including a first region, a second region, and first electrodes at the first region and the second region; a second plate facing the first plate and including second electrodes that face the first electrodes; and a liquid crystal layer between the first plate and the second plate including a plurality of liquid crystal molecules, including: forming a backward phase slope by applying a first driving signal to the first electrodes and the second electrodes which correspond to the first region; and forming a forward phase slope by applying a second driving signal that is different from the first driving signal to the first electrodes and the second electrodes which correspond to the second region, wherein a first pretilt angle of the liquid crystal molecules positioned at the first region and a second pretilt angle of the liquid crystal molecules positioned at the second region are symmetrical to each other with respect to an interface between the first region and the second region.

The first pretilt angle of the liquid crystal molecules positioned at the first region may be in a range of 84 to 88 degrees with respect to a surface of the first plate.

The first pretilt angle of the liquid crystal molecules positioned at the second region may be in a range of 92 to 96 degrees with respect to the surface of the first plate.

The first electrodes corresponding to the first region may include a first unit region and a second unit region which are adjacent to each other, and when the first driving signal is applied to the first electrodes and the second electrodes which correspond to the first region, an absolute value of a first voltage applied to the first unit region may be greater than an absolute value of a second voltage applied to the second unit region.

When the first driving signal is applied to the first electrodes and the second electrodes which correspond to the first region, polarities of the first voltage and the second voltage may be the same for a voltage of the second electrode.

The first electrodes corresponding to the second region may include a third unit region and a fourth unit region which are adjacent to each other, and when the second driving signal is applied to the first electrodes and the second electrodes which correspond to the second region, an absolute value of a third voltage applied to the third unit region may be greater than an absolute value of a fourth voltage applied to the fourth unit region.

When the second driving signal is applied to the first electrodes and the second electrodes which correspond to the second region, polarities of the third voltage and the fourth voltage may be the same for the voltage of the second electrode.

The first voltage and the fourth voltage may be the same, and the second voltage and the third voltage may be the same.

Each of the first unit region, the second unit region, the third unit region, and the fourth unit region may include at least one first electrode.

An exemplary embodiment of the present invention provides a liquid crystal lens panel including: a first plate including a first region, a second region, and first electrodes at the first region and the second region; a second plate facing the first plate and including second electrodes that face the first electrodes; and a liquid crystal layer between the first plate and the second plate including a plurality of liquid crystal molecules, wherein the first electrodes and the second electrodes which correspond to the first region receive a first driving signal to form a backward phase slope, the first electrodes and the second electrodes which correspond to the second region receive a second driving signal that is different from the first driving signal to form a forward phase slope, and a first pretilt angle of the liquid crystal molecules positioned at the first region and a second pretilt angle of the liquid crystal molecules positioned at the second region are symmetrical to each other with respect to an interface between the first region and the second region.

According to an exemplary embodiments of the present invention, it is possible to easily adjust planar rotation angles of liquid crystal molecules to modulate light phases and control rotation directions of the liquid crystal molecules to make various light diffraction angles by aligning the liquid crystal lens panel into two regions at which pretilt angles of liquid crystal molecules are symmetrical to each other and applying symmetric voltages to each unit region included in the two regions. Further, in the light phase modulation, voltages are symmetrically applied to each unit region, and thus no additional channel is required for voltage application. Accordingly, an outer peripheral portion of the liquid crystal lens panel can be reduced in size.

### BRIEF DESCRIPTION OF THE DRAWINGS

FIG. 1 is a perspective view of a liquid crystal lens panel according to an exemplary embodiment of the present invention;

FIG. 2 is a top plan view illustrating an alignment direction in a first substrate and a second substrate included in an optical modulation device according to an exemplary embodiment of the present invention;

FIG. 3 is a view showing a process of assembling the first plate and the second plate shown in FIG. 2;

FIG. 4 schematically illustrates a liquid crystal alignment of a liquid crystal lens panel according to an exemplary embodiment of the present invention;

FIG. 5 is a perspective view illustrating an arrangement of liquid crystal molecules when no voltage difference is applied to a first plate and a second plate of a liquid crystal lens panel according to an exemplary embodiment of the present invention;

FIG. 6 shows cross-sectional views illustrating the liquid crystal lens panel taken along the lines I, II, and III illustrated in FIG. 5;

FIG. 7 is a perspective view illustrating an arrangement of liquid crystal molecules when a voltage difference is applied to a first plate and a second plate of a liquid crystal lens panel according to an exemplary embodiment of the present invention;

FIG. 8 shows cross-sectional views illustrating the liquid crystal lens panel taken along lines I, II, and III illustrated in FIG. 7;

FIG. 9 is a perspective view of a region A of a liquid crystal panel according to an exemplary embodiment of the present invention;

FIG. 10 is a cross-sectional view taken along the line IV of FIG. 9 illustrating a secure arrangement of liquid crystal molecules after a driving signal is applied to a liquid crystal panel according to an exemplary embodiment of the present invention, and a graph illustrating a corresponding phase variation;

FIG. 11 is a perspective view illustrating a region B of a liquid crystal panel according to an exemplary embodiment of the present invention;

FIG. 12 is a cross-sectional view taken along the line V of FIG. 11 illustrating a secure arrangement of liquid crystal molecules after driving signals are sequentially applied to a liquid crystal panel according to an exemplary embodiment of the present invention, and a graph illustrating a corresponding phase variation;

FIG. 13 is a graph illustrating a phase variation according to positions of a lens using a liquid crystal lens panel according to an exemplary embodiment of the present invention; and

FIG. 14 and FIG. 15 illustrate a structure of a stereoscopic image display device as one example of an optical device employing a liquid crystal lens panel according to an exemplary embodiment of the present invention, and methods for displaying a 2D image and a 3D image.

### DETAILED DESCRIPTION

Embodiments of the present invention will be described more fully hereinafter with reference to the accompanying drawings, in which exemplary embodiments of the present invention are shown. As those skilled in the art would realize, the described embodiments may be modified in various suitable ways, all without departing from the spirit or scope of the present invention.

To clearly describe embodiments of the present invention, parts that are irrelevant to the description may be omitted, and like numerals refer to like or similar constituent elements (or components) throughout the specification.

Further, because sizes and thicknesses of constituent members shown in the accompanying drawings are arbitrarily given for better understanding and ease of description, embodiments of the present invention are not limited to the illustrated sizes and thicknesses.

In the drawings, the thickness of layers, films, panels, regions, etc., are exaggerated for clarity. In the drawings, for better understanding and ease of description, the thicknesses of some layers and regions are exaggerated.

It will be understood that when an element or layer is referred to as being “on,” “connected to,” “coupled to,” “connected with,” “coupled with,” or “adjacent to” another element or layer, it can be “directly on,” “directly connected to,” “directly coupled to,” “directly connected with,” “directly coupled with,” or “directly adjacent to” the other element or layer, or one or more intervening elements or layers may be present. Further “connection,” “connected,” etc. may also refer to “electrical connection,” “electrically connect,” etc. depending on the context in which they are used as those skilled in the art would appreciate. When an element or layer is referred to as being “directly on,” “directly connected to,” “directly coupled to,” “directly connected with,” “directly coupled with,” or “immediately adjacent to” another element or layer, there are no intervening elements or layers present.

It will be understood that, although the terms “first”, “second”, “third”, etc., may be used herein to describe various elements, components, regions, layers, and/or sections, these elements, components, regions, layers and/or sections should not be limited by these terms. These terms are used to distinguish one element, component, region, layer or section from another element, component, region, layer or section. Thus, a first element, component, region, layer, or section discussed below could be termed a second element, component, region, layer, or section, without departing from the spirit and scope of the present invention.

The terminology used herein is for the purpose of describing particular embodiments and is not intended to be limiting of the present invention. As used herein, the singular forms “a” and “an” are intended to include the plural forms as well, unless the context clearly indicates otherwise. It will be further understood that the terms “comprise,” “comprises,” “comprising,” “includes,” “including,” and “include,” when used in this specification, specify the presence of stated features, integers, steps, operations, elements, and/or components, but do not preclude the presence or addition of one or more other features, integers, steps, operations, elements, components, and/or groups thereof.

Further, in the specification, the word “on” means positioning on or below the object portion, but does not essentially mean positioning on the upper side of the object portion based on a gravitational direction. Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

Further, it will also be understood that when one element, component, region, layer and/or section is referred to as being “between” two elements, components, regions, layers, and/or sections, it can be the only element, component, region, layer and/or section between the two elements, components, regions, layers, and/or sections, or one or more intervening elements, components, regions, layers, and/or sections may also be present.

As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the present invention refers to “one or more embodiments of the present invention.” Also, the term “exemplary” is intended to refer to an example or illustration.

As used herein, the term “substantially,” “about,” and similar terms are used as terms of approximation and not as terms of degree, and are intended to account for the inherent deviations in measured or calculated values that would be recognized by those of ordinary skill in the art.

As used herein, the terms “use,” “using,” and “used” may be considered synonymous with the terms “utilize,” “utilizing,” and “utilized,” respectively.

Further, in the specification, the phrase “in a plan view (or in-plane)” means when an object portion is viewed from above, and the phrase “in a cross-section” means when a cross-section taken by vertically cutting an object portion is viewed from the side.

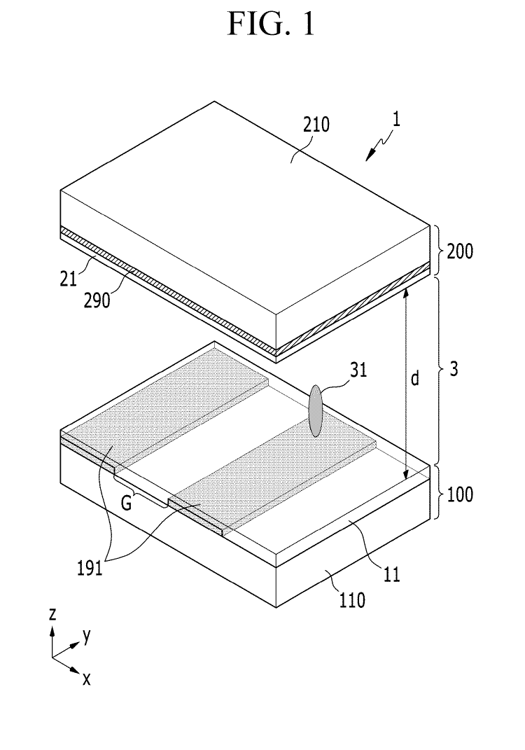

Hereinafter, a liquid crystal lens panel according to an exemplary embodiment of the present invention will be described with reference to FIG. 1 to FIG. 3.

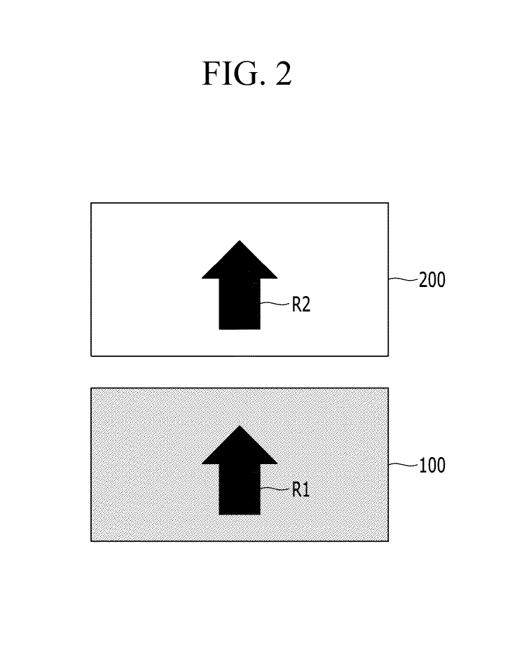

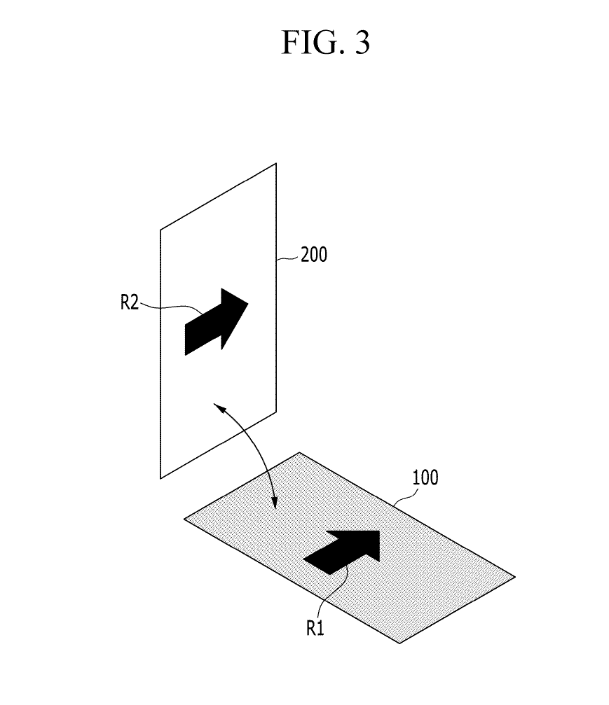

FIG. 1 is a perspective view of a liquid crystal lens panel according to an exemplary embodiment of the present invention. FIG. 2 is a top plan view illustrating an alignment direction in a first substrate and a second substrate included in an optical modulation device according to an exemplary embodiment of the present invention. FIG. 3 is a view showing a process of assembling the first plate and the second plate shown in FIG. 2.

Referring to FIG. 1, the liquid crystal lens panel 1 according to the present exemplary embodiment includes a first plate 100 and a second plate 200 which are disposed to face each other and a liquid crystal layer 3 interposed between the first plate 100 and the second plate 200.

The first plate 100 includes a first substrate 110 made of glass, plastic, and/or the like. The first substrate 110 may be rigid or flexible, and a surface thereof may be flat or at least a part thereof may be bent.

A plurality of lower electrodes 191 are formed on the first substrate 110. The lower electrodes 191 include a conductive material, and may include a transparent conductive material such as ITO and/or IZO, or a metal. The lower electrodes 191 may receive voltages from a voltage application unit, and the lower electrodes 191 that are different from each other (e.g., adjacent to each other or spaced from each other) may receive different voltages.

The lower electrodes 191 may be arranged along a direction (e.g., a predetermined direction), for example, in an x-axis direction, and each lower electrode 191 may extend in a direction perpendicular to the arranged direction, i.e., a y-axis direction

The width of a space G between the adjacent lower electrodes 191 may be variously controlled depending on design conditions of the liquid crystal lens panel 1. A ratio of the width of the lower electrodes 191 and the width of the space G adjacent thereto may be about N:1 (N is a real number of 1 or more).

The second plate 200 may include a second substrate 210 that may be formed of glass, plastic, and/or the like. The second substrate 210 may be rigid or flexible, and may be flat or bent at least in part.

An upper electrode 290 is disposed on the second substrate 210. The upper electrode 290 includes the conductive material, and may include a transparent conductive material such as ITO and/or IZO and/or a metal. The upper electrode 290 may receive a voltage from a voltage application unit. The upper electrode 290 may be formed on the entire second substrate 210, or may be patterned to include a plurality of separated portions.

The liquid crystal layer 3 includes a plurality of liquid crystal molecules 31. The liquid crystal molecules 31 may have negative dielectric anisotropy such that they may be arranged in a transverse direction with respect to a direction of the electric field generated in the liquid crystal layer 3. The liquid crystal molecules 31 are aligned substantially vertically with respect to the second plate 200 and the first plate 100 in the absence of an electric field generated in the liquid crystal layer 3, and may be pretilted (e.g., pretilted in a predetermined direction). The liquid crystal molecules 31 may be nematic liquid crystal molecules.

A height d of a cell gap of the liquid crystal layer 3 may substantially satisfy Equation 1 with respect to light (e.g., light having a predetermined wavelength). As a result, the liquid crystal lens panel 1 according to an exemplary embodiment of the present invention may substantially function as a half-wavelength plate and be used as a diffraction grid, a lens, and/or the like.

$$\frac{λ}{2} \times 1.3 \geq Δ nd \geq \frac{λ}{2} \qquad Equation 1$$

In Equation 1, And is a phase retardation value of light passing through the liquid crystal layer 3.

A first aligner 11 is positioned at an inner surface of the first plate 100 and a second aligner 21 is positioned at the inner surface of the second plate 200. The first aligner 11 and the second aligner 21 may be vertical alignment layers, and may have an alignment force produced by a photoalignment process, thereby determining a pretilt direction of the liquid crystal molecules 31 near the first plate 100 and the second plate 200. After an alignment material including a photosensitive polymer material is coated on inner surfaces of the first plate 100 and the second plate 200, a photo-polymerization material is formed by irradiating light such as ultraviolet rays thereto, whereby the first aligner 11 and the second aligner 21 can be aligned.

Referring to FIG. 2, the alignment directions R1 and R2 of two aligners 11 and 21 respectively located at the inner surfaces of the first plate 100 and the second plate 200 may be substantially parallel. Further, the alignment directions R1 and R2 of the aligners 11 and 21 are constant or substantially constant.

Referring to FIG. 3, the first plate 100 and the second plate 200 including the aligners 11 and 21 that are substantially aligned parallel are aligned with each other and assembled to form the liquid crystal lens panel 1 according to the present exemplary embodiment.

Alternatively, vertical positions of the first plate 100 and the second plate 200 may be changed.

As such, according to this exemplary embodiment of the present invention, the aligners 11 and 21 formed on the first plate 100 and the second plate 200 of the liquid crystal lens panel 1 including the liquid crystal molecules 31 are parallel to each other and each alignment direction of the aligners 11 and 21 is constant or substantially constant so that the alignment process of the liquid crystal lens panel 1 is simplified and a complicated alignment process is not required, thereby simplifying a manufacturing process of the liquid crystal lens panel 1. Accordingly, a failure of the liquid crystal lens panel 1 due to alignment failure may be prevented or substantially prevented. Therefore, a large-sized liquid crystal lens panel can be easily manufactured.

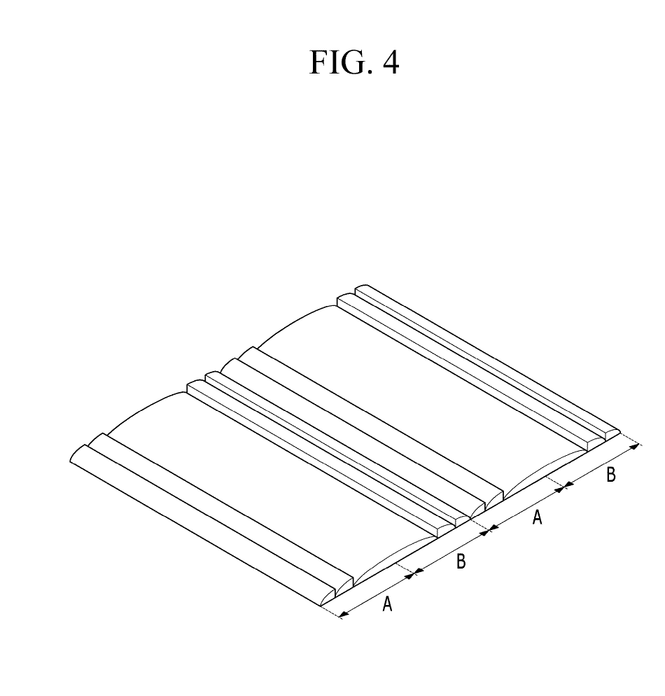

Hereinafter, an alignment of this liquid crystal lens panel will be described with reference to FIG. 4.

FIG. 4 schematically illustrates a liquid crystal alignment of a liquid crystal lens panel according to an exemplary embodiment of the present invention.

As described above with reference to FIG. 3, the first aligner 11 and the second aligner 21 of the liquid crystal lens panel are aligned through a photoalignment process to determine a pretilt direction of the liquid crystal molecules 31.

Referring to FIG. 4, the liquid crystal lens panel according to the present exemplary embodiment is divided into regions A and regions B to be aligned.

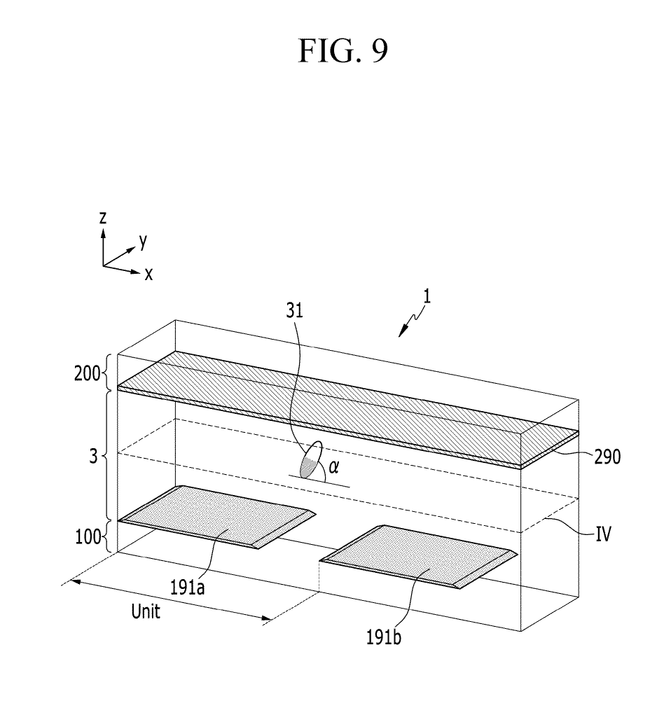

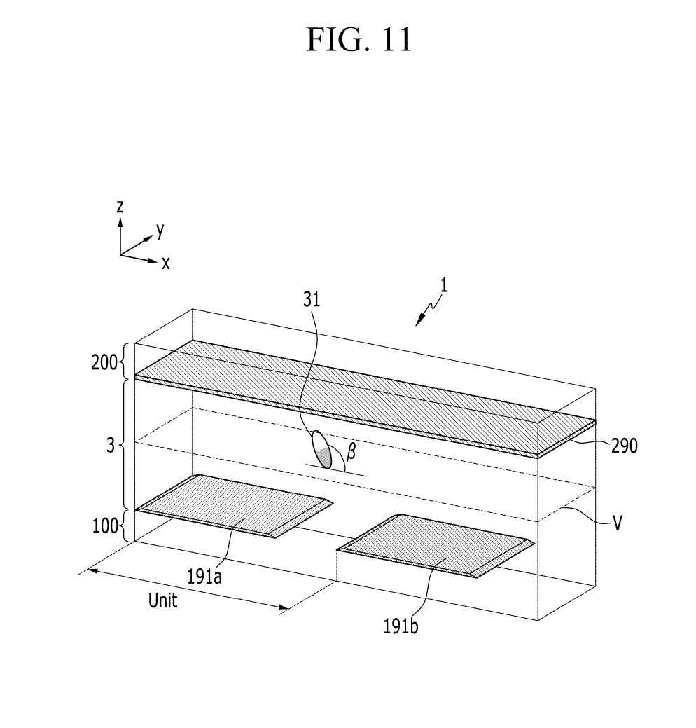

As described with reference to FIG. 2, alignment directions of the liquid crystal molecule 31 positioned at the regions A and B are constant or substantially constant. However, pretilt angles of the liquid crystal molecules 31 positioned at the regions A and B may be different. For example, the pretilt angles of the liquid crystal molecules 31 positioned at the regions A and B may be symmetrical to each other with respect to an interface between the regions A and B. These pretilt angles of the liquid crystal molecules 31 positioned at the regions A and B will be described later in detail with reference to FIG. 9 and FIG. 11.

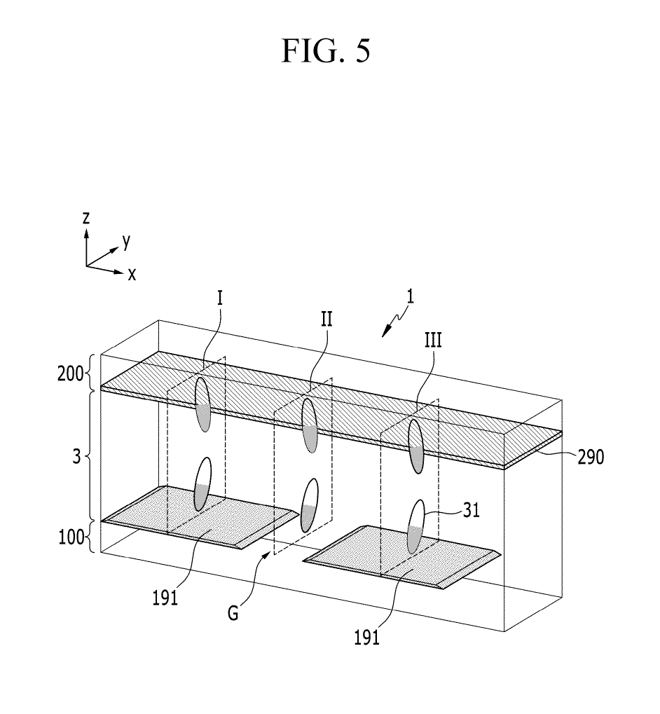

Next, an operation of a liquid crystal lens panel according to an exemplary embodiment of the present invention will be described with reference to FIG. 5 to FIG. 8, along with FIG. 1 to FIG. 3.

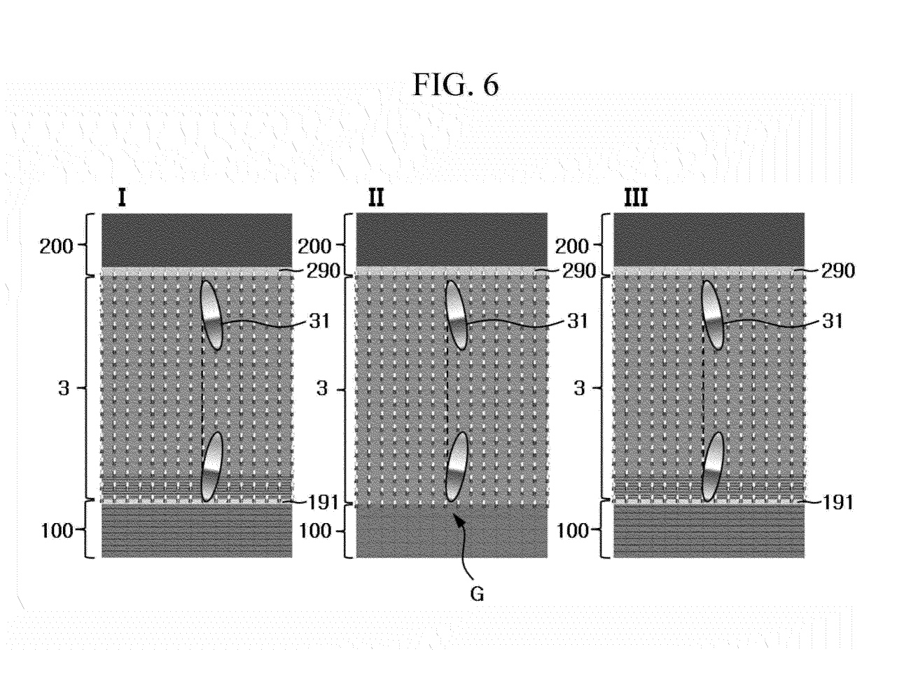

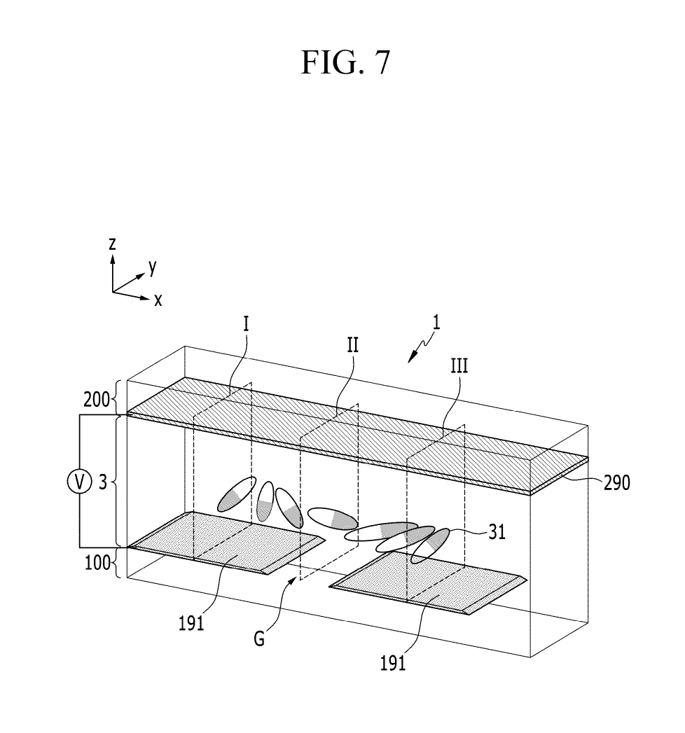

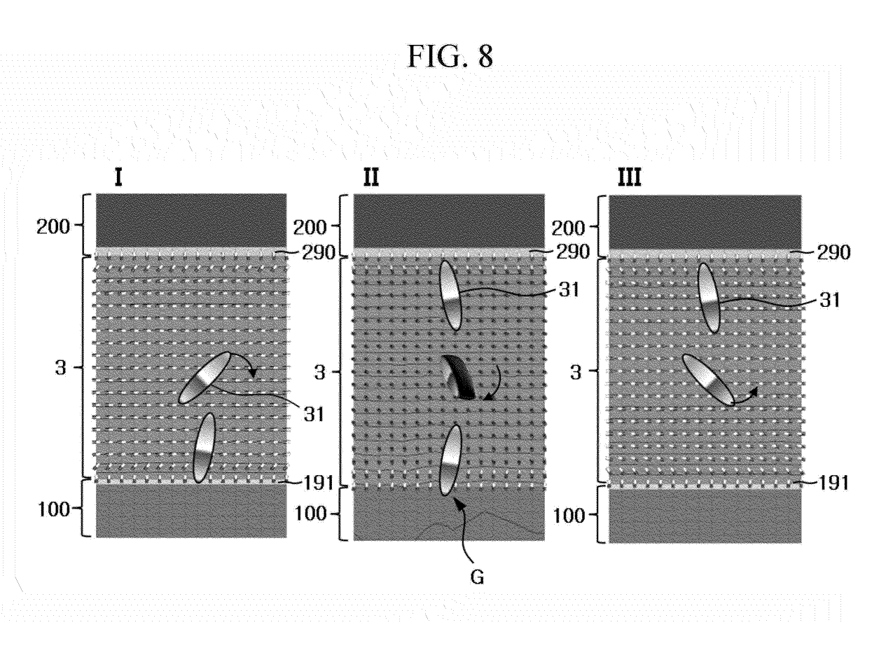

FIG. 5 is a perspective view illustrating an arrangement of liquid crystal molecules when no voltage difference is applied to a first plate and a second plate of a liquid crystal lens panel according to an exemplary embodiment of the present invention. FIG. 6 is cross-sectional views illustrating the liquid crystal lens panel taken along lines I, II, and III illustrated in FIG. 5. FIG. 7 is a perspective view illustrating an arrangement of liquid crystal molecules when a voltage difference is applied to a first plate and a second plate of a liquid crystal lens panel according to an exemplary embodiment of the present invention. FIG. 8 is cross-sectional views illustrating the liquid crystal lens panel taken along the lines I, II, and III illustrated in FIG. 7.

Referring to FIG. 5, when the voltage difference is not applied between the lower electrode 191 of the first plate 100 and the upper electrode 290 of the second plate 200 such that the electric field is not generated in the liquid crystal layer 3, the liquid crystal molecules 31 are arranged with an initial pretilt angle.

FIG. 6 is the cross-sectional view taken along the line I corresponding to one of the lower electrodes 191 of the liquid crystal lens panel 1 shown in FIG. 4, the cross-sectional view taken along the line II corresponding to the space G between two adjacent lower electrodes 191, and the cross-sectional view taken along the line III corresponding to the lower electrode 191 adjacent to the other lower electrode 191, and as shown, the arrangement of the liquid crystal molecules 31 may be constant or substantially constant.

In FIG. 6, and such, it is illustrated that some of the liquid crystal molecules 31 penetrate the first plate 100 or the second plate 200. However, this is simply for convenience in the explanation, and in reality, the liquid crystal molecules 31 are positioned to not penetrate the first plate 100 or the second plate 200. This is also true of the following drawings.

The liquid crystal molecules 31 near the first plate 100 and the second plate 200 are initially aligned along the alignment direction parallel to the aligners 11 and 21, and thus the pretilt direction of the liquid crystal molecule 31 near the first plate 100 and the pretilt direction of the liquid crystal molecule 31 near the second plate 200 are not parallel to each other but are opposite. That is, the liquid crystal molecules 31 near the first plate 100 and the liquid crystal molecules 31 near the second plate 200 may be inclined to be symmetrical to each other with reference to a horizontal center line extending horizontally along the center of the liquid crystal layer 3. For example, when the liquid crystal molecules 31 near the first plate 100 are inclined to the right, the liquid crystal molecules 31 near the second plate 200 may be inclined to the left.

Referring to FIG. 7 and FIG. 8, a voltage difference of more than the threshold voltage is applied between the lower electrode 191 of the first plate 100 and the upper electrode 290 of the second plate 200, and thus the liquid crystal molecules 31 having negative dielectric anisotropy tend to be inclined in a direction perpendicular to the direction of the electric field immediately after the electric field is generated in the liquid crystal layer 3. Accordingly, as shown in FIG. 7 and FIG. 8, the liquid crystal molecules 31 are mostly inclined to be parallel to the surface of the first plate 100 or the second plate 200 to have an in-plane arrangement and the long axes of the liquid crystal molecules 31 are rotated and arranged in a plan view. The in-plane arrangement indicates an arrangement of the long axes of the liquid crystal molecules 31 that are parallel to the surface of the first plate 100 or the second plate 200.

An in-plane rotation angle of the liquid crystal molecules 31, i.e., the azimuthal angle, may be varied according to the voltage applied to the lower electrode 191 and the upper electrode 290, and as a result may be changed in a spiral according to the position of the x-axis direction.

Next, a method of realizing a forward phase slope and a backward phase slope by using the liquid crystal lens panel 1 according to an exemplary embodiment of the present invention will be described with reference to FIG. 9 to FIG. 12 along with the above-described drawings

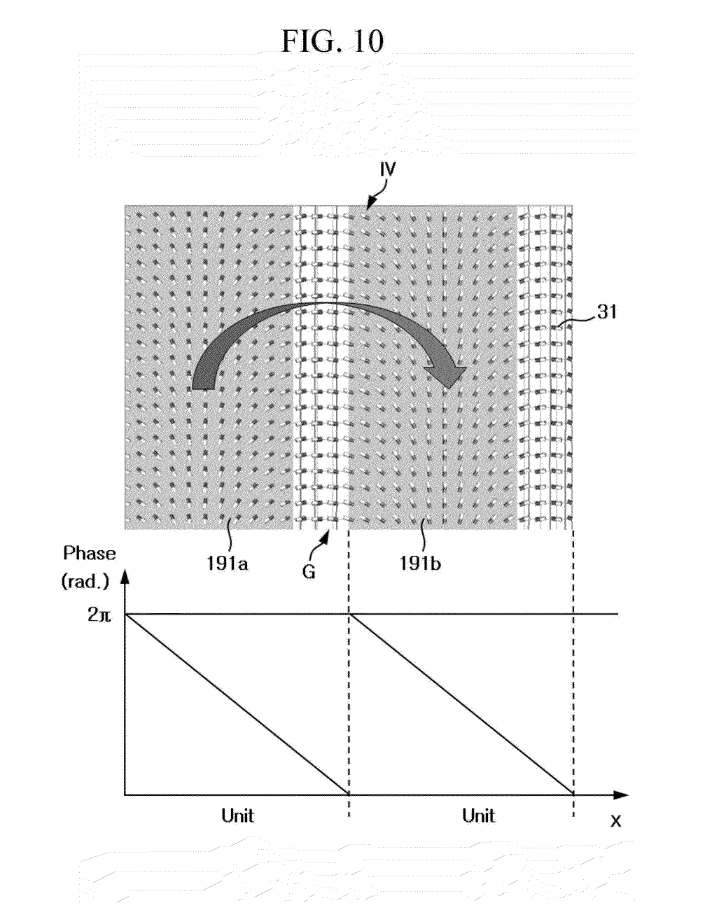

First, a method of realizing the backward phase slope by using the liquid crystal lens panel 1 according to an exemplary embodiment of the present invention will be described with reference to FIG. 9 and FIG. 10.

FIG. 9 is a perspective view of a region A of a liquid crystal panel according to an exemplary embodiment of the present invention. FIG. 10 is a cross-sectional view taken along the line IV of FIG. 9 illustrating a secure arrangement of liquid crystal molecules after a driving signal is applied to a liquid crystal panel according to an exemplary embodiment of the present invention, and a graph illustrating a corresponding phase variation.

Referring to FIG. 9, the region A of the liquid crystal panel 1 according to the present exemplary embodiment may include a plurality of unit regions Unit, and each unit region Unit may include at least one lower electrode 191. The present exemplary embodiment, based on the case where each unit region Unit includes one lower electrode 191, and two lower electrodes 191a and 191b which are respectively disposed in two adjacent unit regions Unit, will now be described. The two lower electrodes 191a and 191b are referred to as a first electrode 191a and a second electrode 191b.

When no voltage is applied to the first and second electrodes 191a and 191b and the upper electrode 290, the liquid crystal molecules 31 are initially aligned in a direction substantially perpendicular to the first plate 100 and the second plate 200. As described above with reference to FIG. 4, the liquid crystal molecules 31 positioned at the region A of the liquid crystal panel according to the present exemplary embodiment are pretilted. A pretilt angle α of the liquid crystal molecules 31 may be in a range of 84 to 88 degrees.

The first and second electrodes 191a and 191b may receive a voltage of 0 V with reference to the voltage of the upper electrode 290, and/or may receive a voltage of a threshold voltage Vth or less at which the alignment of the liquid crystal molecules 31 begins to change.

Referring to FIG. 10, a region at which the liquid crystal molecules 31 are arranged while rotating by 180 degrees along an x-axis direction may be defined as one unit region Unit. In the present exemplary embodiment, one unit region Unit may include a space G between the first lower electrode 191a and the second lower electrode 191b adjacent thereto.

The liquid crystal molecules 31 are mostly inclined to be substantially parallel to the surface of the first plate 100 or the second plate 200, thereby forming an in-plane arrangement, and long axes thereof are subjected to in-plane rotation, thereby forming a spiral arrangement, for example, an n-shaped arrangement. Azimuthal angles of the long axes of the liquid crystal molecules 31 may be changed from about 180° to about 0° on a pitch period of the lower electrode 191. A portion where the azimuthal angles of the long axes of the liquid crystal molecules 31 are changed from about 180° to about 0° may form one n-shape arrangement.

A time (e.g., a predetermined time) may be required until the arrangement of the liquid crystal molecules 31 is stable after the liquid crystal lens panel 1 receives a driving signal. The liquid crystal lens panel 1, forming the backward phase scope, may continually receive the driving signal.

As described above, when the liquid crystal lens panel 1 satisfies Equation 1 to be substantially realized as the half-wavelength plate, the rotation direction of the circularly-polarized light that is incident is reversely (or inversely) changed. FIG. 10 illustrates the phase variation according to the position of the x-axis direction when the right-circularly-polarized light is introduced to the active area of the liquid crystal lens panel 1. The right-circularly-polarized light passing through the active area of the liquid crystal lens panel 1 is changed into the left-circularly-polarized light, and a phase retardation value of the liquid crystal layer 3 is changed according to the x-axis direction so that a phase of the emitted circularly-polarized light is continuously changed.

When a light axis of the half-wavelength plate is generally subjected to an in-plane rotation by φ degrees, the phase of the outputted light is changed by 2φ degrees. Accordingly, as shown in FIG. 10, the phase of the light emitted from one unit region Unit in which the azimuthal angle of the long axes of the liquid crystal molecules 31 is changed to 180° is changed from 2π (radian) to 0 in the x-axial direction. This is referred to as a backward phase slope. The phase change may be repeated every unit region Unit, and the backward phase slope of the lens changing the direction of the light may be implemented by using the liquid crystal lens panel 1.

Hereinafter, the implementation of the backward phase slope performed by the liquid crystal lens panel 1 will be described in detail with reference to FIG. 10.

First, the adjacent lower electrodes 191a and 191b and the upper electrode 290 may receive driving signals during one frame in order for the liquid crystal lens panel 1 to implement the backward phase slope. While a voltage difference is formed between the lower electrodes 191a and 191b of the first plate 100 and the upper electrode 290 of the second plate 200, a voltage difference is also formed between the first lower electrode 191a and the second lower electrode 191b which are adjacent to each other. For example, the magnitude of an absolute value of the voltage applied to the first lower electrode 191a may be greater than that of an absolute value of the voltage applied to the second lower electrode 191b. Further, the voltage applied to the upper electrode 290 is different from the voltages applied to the lower electrodes 191a and 191b. For example, an absolute value of the voltage applied to the upper electrode 290 may be smaller than absolute values of the voltages applied to the first and second lower electrodes 191a and 191b. For example, voltages of 7, 5 and 0 V may be respectively applied to the first lower electrode 191a, the second lower electrode 191b, and the upper electrode 290.

Alternatively, when the unit region Unit includes a plurality of lower electrodes 191, the same or substantially the same voltage may be applied to all the lower electrodes 191 of one unit region Unit, or sequentially changed voltages are applied thereto by the unit of at least one lower electrode 191. Gradually increasing voltages may be applied to the lower electrodes 191 of one side of one unit region by the unit of at least one lower electrode 191, while gradually decreasing voltages may be applied to the lower electrodes 191 of the other side of one unit region by the unit of at least one lower electrode 191.

The voltages applied to the lower electrodes 191 of all unit regions Unit may have the constant or substantially constant polarity as a positive polarity or a negative polarity with reference to the voltage of the upper electrode 290. Further, the polarity of the voltage applied to the lower electrode 191 may be reversed by the period of at least one frame.

Thus, as shown in FIG. 10, the liquid crystal molecules 31 are rearranged according to an electric field generated in the liquid crystal layer 3. For example, the liquid crystal molecules 31 are mostly inclined to be substantially parallel to the surface of the first plate 100 or the second plate 200, thereby forming an in-plane arrangement, and long axes thereof are subjected to in-plane rotation, thereby forming a spiral arrangement, for example, an n-shaped arrangement as shown in FIG. 10. Azimuthal angles of the long axes of the liquid crystal molecules 31 may be changed from about 180° to about 0° on a pitch period of the lower electrode 191. A portion where the azimuthal angles of the long axes of the liquid crystal molecules 31 are changed from about 180° to about 0° may form one n-shape arrangement.

A time (e.g., a predetermined time) may be required until the arrangement of the liquid crystal molecules 31 is stable after the liquid crystal lens panel 1 receives a driving signal, and the liquid crystal lens panel 1 forming the backward phase scope may continually receive the driving signal.

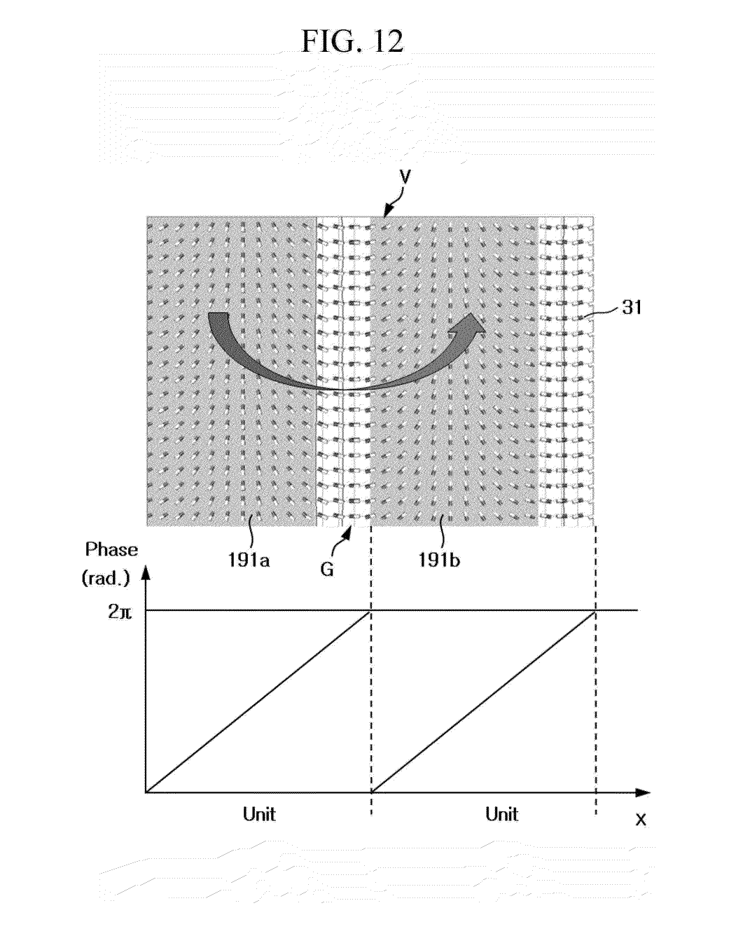

Hereinafter, a method of implementing the forward phase slope by using the liquid crystal lens panel 1 according to an exemplary embodiment of the present invention will be described with reference to FIG. 11 and FIG. 12.

FIG. 11 is a perspective view illustrating a region B of a liquid crystal panel according to an exemplary embodiment of the present invention. FIG. 12 is a cross-sectional view taken along the line V of FIG. 11 illustrating a secure arrangement of liquid crystal molecules after driving signals are sequentially applied to a liquid crystal panel according to an exemplary embodiment of the present invention, and a graph illustrating a corresponding phase variation.

Referring to FIG. 11, the region B of the liquid crystal panel according to the present exemplary embodiment is substantially the same as the region A illustrated in FIG. 9, except for the pretilt angle of the liquid crystal molecules. Accordingly, the same structure is not illustrated. As described above with reference to FIG. 4, the liquid crystal molecules 31 positioned at the region A of the liquid crystal panel according to the present exemplary embodiment are pretilted. A pretilt angle β of the liquid crystal molecules 31 may be in a range of 92 to 96 degrees

In other words, the pretilt angle β of the liquid crystal molecules 31 positioned at the region B of the liquid crystal panel and the pretilt angle α of the liquid crystal molecules 31 positioned at the region A thereof may be symmetrical to each other with respect to an interface between the regions A and B.

Referring to FIG. 12, a region at which the liquid crystal molecules 31 are arranged while rotating by 180 degrees along an x-axis direction may be defined as one unit region Unit. In the present exemplary embodiment, one unit region Unit may include a space G between the first lower electrode 191a and the second lower electrode 191b adjacent thereto.

The liquid crystal molecules 31 are mostly inclined to be substantially parallel to the surface of the first plate 100 or the second plate 200, thereby forming an in-plane arrangement, and long axes thereof are subjected to in-plane rotation, thereby forming a spiral arrangement, for example, an n-shaped arrangement. Azimuthal angles of the long axes of the liquid crystal molecules 31 may be changed from about 180° to about 0° on a pitch period of the lower electrode 191. A portion where the azimuthal angles of the long axes of the liquid crystal molecules 31 are changed from about 180° to about 0° may form one u-shape arrangement.

As described above, when the liquid crystal lens panel 1 satisfies Equation 1 to be substantially realized as the half-wavelength plate, the rotation direction of the circularly-polarized light that is incident is reversely (or inversely) changed. FIG. 12 illustrates the phase variation according to the position of the x-axis direction when the right-circularly-polarized light is introduced to the active area of the liquid crystal lens panel 1. The right-circularly-polarized light passing through the active area of the liquid crystal lens panel 1 is changed into the left-circularly-polarized light, and a phase retardation value of the liquid crystal layer 3 is changed according to the x-axis direction so that a phase of the emitted circularly-polarized light is continuously changed.

When a light axis of the half-wavelength plate is generally subjected to an in-plane rotation by φ degrees, the phase of the outputted light is changed by 2φ degrees. Accordingly, as shown in FIG. 10, the phase of the light emitted from one unit region Unit in which the azimuthal angle of the long axes of the liquid crystal molecules 31 is changed to 180° is changed from 0 to 2π (radian) in the x-axial direction. This is referred to as a forward phase slope. The phase change may be repeated every unit region Unit, and the forward phase slope of the lens changing the direction of the light may be implemented by using the liquid crystal lens panel 1.

Hereinafter, the implementation of the forward phase slope performed by the liquid crystal lens panel 1 will be described in detail with reference to FIG. 12.

First, the adjacent lower electrodes 191a and 191b and the upper electrode 290 may receive driving signals during one frame in order for the liquid crystal lens panel 1 to implement the forward phase slope. While a voltage difference is formed between the lower electrodes 191a and 191b of the first plate 100 and the upper electrode 290 of the second plate 200, a voltage difference is also formed between the first lower electrode 191a and the second lower electrode 191b which are adjacent to each other. For example, the magnitude of an absolute value of the voltage applied to the second lower electrode 191b may be greater than that of an absolute value of the voltage applied to the first lower electrode 191a. Further, the voltage applied to the upper electrode 290 is different from the voltages applied to the lower electrodes 191a and 191b. For example, an absolute value of the voltage applied to the upper electrode 290 may be smaller than absolute values of the voltages applied to the first and second lower electrodes 191a and 191b. For example, voltages of 5, 7, and 0 V may be respectively applied to the first lower electrode 191a, the second lower electrode 191b, and the upper electrode 290.

Herein, when implementing the backward phase slope of the liquid crystal lens panel 1 illustrated in FIG. 10, voltages of 7, 5, and 0 V may be respectively applied to the first lower electrode 191a, the second lower electrode 191b, and the upper electrode 290. In the case of the forward phase slope, voltages of 5, 7, and 0 V may be respectively applied to the first lower electrode 191a, the second lower electrode 191b, and the upper electrode 290. That is, the voltage applied to the first lower electrode 191a when implementing the backward phase slope is the same or substantially the same as the voltage applied to the second lower electrode 191b when implementing the forward phase slope. Further, the voltage applied to the second lower electrode 191b when implementing the backward phase slope is the same as the voltage applied to the first lower electrode 191a when implementing the forward phase slope. As such, when implementing the backward phase slope and the forward phase slope, voltages may be symmetrically applied to the respective unit regions, and thus no additional channel is required according to the application of voltages. The voltages are applied to the unit regions by using wires and circuits disposed at an outer peripheral portion of the liquid crystal lens panel. As described above, no additional channel is required, and thus the size of the outer peripheral portion can be reduced,

Alternatively, when the unit region Unit includes a plurality of lower electrodes 191, the same voltage may be applied to all the lower electrodes 191 of one unit region Unit, or sequentially changed voltages are applied thereto by the unit of at least one lower electrode 191. Gradually increasing voltages may be applied to the lower electrodes 191 of one side of one unit region by the unit of at least one lower electrode 191, while gradually decreasing voltages may be applied to the lower electrodes 191 of the other side of one unit region by the unit of at least one lower electrode 191.

The voltages applied to the lower electrodes 191 of all unit regions Unit may have the constant or substantially constant polarity as a positive polarity or a negative polarity with reference to the voltage of the upper electrode 290. Further, the polarity of the voltage applied to the lower electrode 191 may be reversed by the period of at least one frame.

Thus, as shown in FIG. 12, the liquid crystal molecules 31 are rearranged according to an electric field generated in the liquid crystal layer 3. For example, most liquid crystal molecules 31 are inclined to be substantially parallel to the surface of the first plate 100 or the second plate 200, thereby forming an in-plane arrangement, and long axes thereof are subjected to in-plane rotation, thereby forming a spiral arrangement, for example, a u-shaped arrangement as shown in FIG. 12. Azimuthal angles of the long axes of the liquid crystal molecules 31 may be changed from about 0° to about 180° on a pitch period of the lower electrode 191. A portion where the azimuthal angles of the long axes of the liquid crystal molecules 31 are changed from about 0° to about 180° may form one n-shape arrangement.

A time (e.g., a predetermined time) may be required until the arrangement of the liquid crystal molecules 31 is stable after the liquid crystal lens panel 1 receives a driving signal, and the liquid crystal lens panel 1 forming the forward phase scope may continually receive the driving signal.

As such, according to an exemplary embodiment of the present invention, the in-plane rotation angle of the liquid crystal molecules 31 is easily controlled according to a method of applying the driving signal to variously modulate an optical phase and form various diffraction angles of light.

The liquid crystal lens panel 1 according to an exemplary embodiment of the present invention may realize the forward phase slope and the backward phase slope by differentiating the application method of the driving signal depending on the position described above, thereby forming the lens.

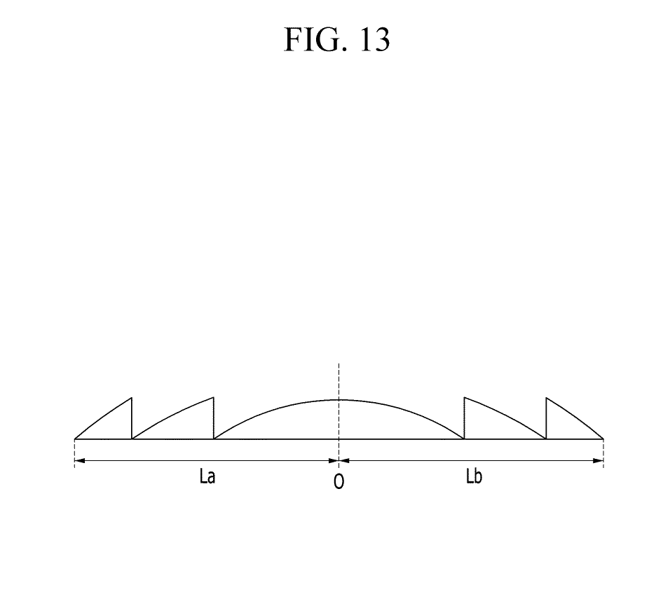

FIG. 13 is a graph illustrating a phase variation according to positions of a lens that can be implemented by using a liquid crystal lens panel according to an exemplary embodiment of the present invention.

FIG. 13 shows the phase change depending on the position of a Fresnel lens as an example of the lens realized by the liquid crystal lens panel 1. The Fresnel lens is a lens using an optical characteristic of a Fresnel zone plate, and may have an effective phase delay which is identical or similar to that of a solid convex lens or a GRIN lens since the refractive index distribution is periodically repeated.

Referring to FIG. 13, based on a center O of one Fresnel lens, a left portion La includes a plurality of forward phase slope regions having different widths in the x-axis direction, and a right portion Lb includes a plurality of backward phase slope regions having different widths in the x-axis direction. Accordingly, a portion of the liquid crystal lens panel 1, which corresponds to the left portion La of the Fresnel lens, can form the backward phase slope, and a portion of the liquid crystal lens panel 1, which corresponds to the right portion Lb of the Fresnel lens, can form the forward phase slope.

The plurality of forward phase slopes included in the left portion La of the Fresnel lens may have different widths depending on the position, and for this purpose, the width of the lower electrode 191 of the optical modulation device corresponding to each forward phase slope portion and/or the number of the lower electrodes 191 included in one unit area (Unit) may be appropriately controlled. Likewise, the plurality of forward phase slopes included in the right portion Lb of the Fresnel lens may have different widths depending on the position, and for this purpose, the width of the lower electrode 191 of the optical modulation device corresponding to each forward phase slope portion and/or the number of the lower electrodes 191 included in one unit area (Unit) may be appropriately controlled.

By controlling the voltages applied to the lower electrode 191 and the upper electrode 290, the phase curvature of the Fresnel lens may also be changed.

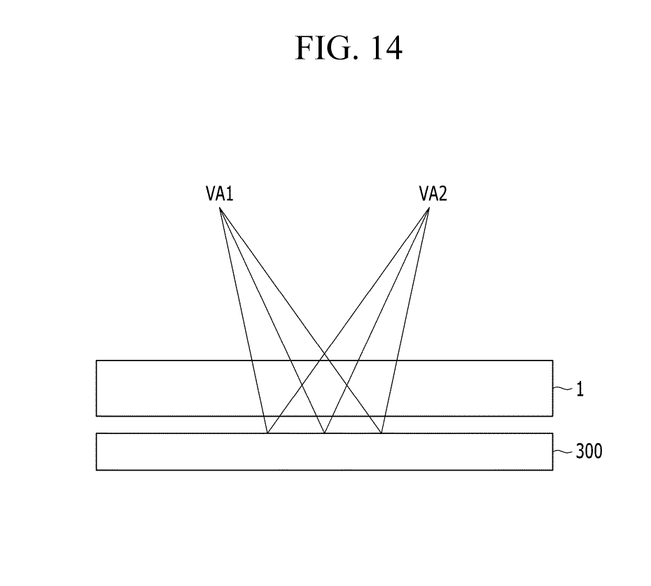

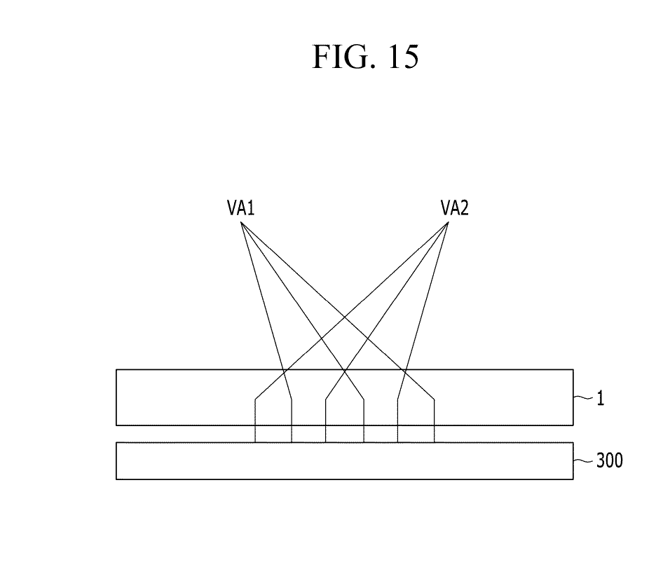

FIG. 14 and FIG. 15 illustrate a structure of a stereoscopic image display device as one example of an optical device employing a liquid crystal lens panel according to an exemplary embodiment of the present invention, and methods for displaying a 2D image and a 3D image.

Referring to FIG. 14 and FIG. 15, the optical device according to an exemplary embodiment of the present invention may serve as a stereoscopic image display device, and may include a display panel 300 and a liquid crystal lens panel 1 disposed in front of a front surface on which an image of the display panel 300 is displayed. The display panel 300 includes a plurality of pixels for displaying an image, and the pixels may be arranged in a matrix form.

The display panel 300 may display a 2D image of each frame displayed by the display panel 300 in a 2D mode as illustrated in FIG. 14, and may divide and display images corresponding to various viewpoints such as a right-eye image and a left-eye image by a spatial division method in a 3D mode as illustrated in FIG. 15. In the 3D mode, some of the pixels may display an image corresponding to any one viewpoint, and the others may display images corresponding to other viewpoints. The number of viewpoints may be two or more.

The liquid crystal lens panel 1 may repetitively implement the Fresnel lens including the plurality of forward phase slope portions and the plurality of backward phase slope portions to divide images displayed on the display panel 300 for each viewpoint.

The liquid crystal lens panel 1 may be switched on/off. When the liquid crystal lens panel 1 is switched on, the stereoscopic image display device operates in the 3D mode, and as illustrated in FIG. 15, the image displayed on the display panel 300 is refracted to form a plurality of Fresnel lenses which display the image at the corresponding viewpoint. When the optical modulation device 1 is turned off, as illustrated in FIG. 14, the image displayed on the display panel 300 is not refracted, but is transmitted to be viewed as the 2D image.

While this invention has been described in connection with what is presently considered to be practical exemplary embodiments, it is to be understood that the invention is not limited to the disclosed embodiments but, on the contrary, is intended to cover various modifications and equivalent arrangements included within the spirit and scope of the appended claims and their equivalents.

Description of Some of the Reference Characters

| | |
|---|---|
| 3: liquid crystal layer | 11, 21: aligner |
| 31: liquid crystal molecule | 100: first plate |
| 110, 210: substrate | 191, 191a, 191b: lower electrode |
| 200: second plate | 290: upper electrode |

What is claimed is:

1. A driving method of a liquid crystal lens panel comprising a first plate comprising a first region, a second region, and first electrodes at the first region and the second region; a second plate facing the first plate and comprising second electrodes that face the first electrodes; and a liquid crystal layer between the first plate and the second plate and comprising a plurality of liquid crystal molecules, the method comprising:
forming a backward phase slope in the liquid crystal layer by applying a first driving signal to the first electrodes and the second electrodes which correspond to the first region; and
forming a forward phase slope in the liquid crystal layer by applying a second driving signal that is different from the first driving signal to the first electrodes and the second electrodes which correspond to the second region,
wherein a first pretilt angle of the liquid crystal molecules positioned at the first region and a second pretilt angle of the liquid crystal molecules positioned at the second region are symmetrical to each other with respect to an interface between the first region and the second region.

2. The driving method of claim 1,
wherein the first pretilt angle of the liquid crystal molecules positioned at the first region is in a range of 84 to 88 degrees with respect to a surface of the first plate.

3. The driving method of claim 2,
wherein the first pretilt angle of the liquid crystal molecules positioned at the second region is in a range of 92 to 96 degrees with respect to the surface of the first plate.

4. The driving method of claim 3,
wherein the first electrodes corresponding to the first region comprise a first unit region and a second unit region which are adjacent to each other, and
when the first driving signal is applied to the first electrodes and the second electrodes which correspond to the first region, an absolute value of a first voltage applied to the first unit region is greater than an absolute value of a second voltage applied to the second unit region.

5. The driving method of claim 4,
wherein, when the first driving signal is applied to the first electrodes and the second electrodes which correspond to the first region, polarities of the first voltage and the second voltage are the same for a voltage of the second electrode.

6. The driving method of claim 5,
wherein the first electrodes corresponding to the second region comprise a third unit region and a fourth unit region which are adjacent to each other, and
when the second driving signal is applied to the first electrodes and the second electrodes which correspond to the second region, an absolute value of a third voltage applied to the third unit region is greater than an absolute value of a fourth voltage applied to the fourth unit region.

7. The driving method of claim 6,
wherein, when the second driving signal is applied to the first electrodes and the second electrodes which correspond to the second region, polarities of the third voltage and the fourth voltage are the same for the voltage of the second electrode.

8. The driving method of claim 7,
wherein the first voltage and the fourth voltage are the same, and
wherein the second voltage and the third voltage are the same.

9. The driving method of claim 8,
wherein each of the first unit region, the second unit region, the third unit region, and the fourth unit region comprises at least one of the first electrodes.

10. A liquid crystal lens panel comprising:
a first plate comprising a first region, a second region, and first electrodes at the first region and the second region;
a second plate facing the first plate and comprising second electrodes that face the first electrodes; and
a liquid crystal layer between the first plate and the second plate and comprising a plurality of liquid crystal molecules,
wherein the first electrodes and the second electrodes which correspond to the first region receive a first driving signal to form a backward phase slope in the liquid crystal layer,
the first electrodes and the second electrodes which correspond to the second region receive a second driving signal that is different from the first driving signal to form a forward phase slope in the liquid crystal layer, and
a first pretilt angle of the liquid crystal molecules positioned at the first region and a second pretilt angle of the liquid crystal molecules positioned at the second region are symmetrical to each other with respect to an interface between the first region and the second region.

11. The liquid crystal lens panel of claim 10,
wherein the first pretilt angle of the liquid crystal molecules positioned at the first region is in a range of 84 to 88 degrees with respect to a surface of the first plate.

12. The liquid crystal lens panel of claim 11,
wherein the first pretilt angle of the liquid crystal molecules positioned at the second region is in a range of 92 to 96 degrees with respect to the surface of the first plate.

13. The liquid crystal lens panel of claim 12,
wherein the first electrodes corresponding to the first region comprise a first unit region and a second unit region which are adjacent to each other, and
when the first driving signal is applied to the first electrodes and the second electrodes which correspond to the first region, an absolute value of a first voltage applied to the first unit region is greater than an absolute value of a second voltage applied to the second unit region.

14. The liquid crystal lens panel of claim 13,
wherein when the first driving signal is applied to the first electrodes and the second electrodes which correspond to the first region, polarities of the first voltage and the second voltage are the same for a voltage of the second electrode.

15. The liquid crystal lens panel of claim 14,
wherein the first electrodes corresponding to the second region comprise a third unit region and a fourth unit region which are adjacent to each other, and
when the second driving signal is applied to the first electrodes and the second electrodes which correspond to the second region, an absolute value of a third voltage applied to the third unit region is greater than an absolute value of a fourth voltage applied to the fourth unit region.

16. The liquid crystal lens panel of claim 15,
wherein when the second driving signal is applied to the first electrodes and the second electrodes which correspond to the second region, polarities of the third voltage and the fourth voltage are the same for the voltage of the second electrode.

17. The liquid crystal lens panel of claim 16,
wherein the first voltage and the fourth voltage are the same, and
wherein the second voltage and the third voltage are the same.

18. The liquid crystal lens panel of claim 17,
wherein each of the first unit region, the second unit region, the third unit region, and the fourth unit region comprises at least one of the first electrodes.
